(19) United States
(12) Patent Application Publication
(10) Pub. No.: US 2022/0067728 A1
(43) Pub. Date: Mar. 3, 2022

(54) DISTRIBUTED LEDGER INTEROPERABILITY SERVICES

(71) Applicant: JPMORGAN CHASE BANK, N.A., New York, NY (US)

(72) Inventors: Michael BELLAMY, Verwood (GB); Lawrence Charles DRAKE, Bournemouth (GB); Debidutta Pruthibiraj SAMANTARAY, Singapore (SG); Raunak RAJPURIA, Singapore (SG); Naveen MALLELA, Singapore (SG); Akshika GUPTA, Singapore (SG)

(21) Appl. No.: 17/460,784

(22) Filed: Aug. 30, 2021

Related U.S. Application Data
(60) Provisional application No. 63/071,727, filed on Aug. 28, 2020.

(51) Int. Cl. G06Q 20/40; G06Q 20/38

(52) U.S. Cl. CPC G06Q 20/401; G06Q 2220/00; G06Q 20/389

(57) ABSTRACT

A method for transaction processing using a ledger interoperability service in a blockchain-based distributed ledger system may include a ledger interoperability service: receiving a pending transaction request for a transaction from a distributed banking ledger; validating the pending transaction request; enriching the validated pending transaction; sending the enriched and validated pending transaction to a posting generation service, wherein the posting generation service creates a posting for the enriched and validated pending transaction request and a posting execution service posts a message including the posting to the ledger interoperability service; encrypting and providing the encrypted message to the distributed banking ledger; receiving an encrypted response message from the distributed banking ledger; decrypting and passing the encrypted response message to the posting execution service, wherein the posting execution service provides the posting, a transaction level status, and/or a posting level status to the posting generation service; and receiving a final confirmation.

### RELATED APPLICATIONS

This application claims priority to, and the benefit of, U.S. Provisional Patent Application Ser. No. 63/071,727 filed Aug. 28, 2020, the disclosure of which is hereby incorporated, by reference, in its entirety.

### BACKGROUND OF THE INVENTION

### 1. Field of the Invention

Embodiments are generally directed to distributed ledger interoperability services.

### 2. Description of the Related Art

Traditionally, banks process payments by including rich data around account master attributes, static account rules, and mapping, that are used by posting services to post transactions to bank general ledgers. Many institutions have decades of technology controls built into their payment applications to comply with regulatory obligations as well as provide an excellent user experience. As value is being transferred and posted on to distributed ledger technology, banks require a way to adapt to these new forms of ledgers that are significantly different in architecture, that require different types of processing, orchestration, and format enrichment.

With distributed ledgers, banks need the ability to post liabilities in the form of on-chain balances to the shared ledger through a process of depositing, transferring, and withdrawing liabilities. Banks have a variety of checks that are performed prior to posting liabilities and there is reporting required after posting the liabilities. These functions of processing payments as well as checking, validating, and reporting are difficult to integrate with distributed ledger architecture for a number of reasons, including the new types of message and data formats required. In addition, the lack of time cut-offs spurred by the potential 24×7 uptime and operational availability of blockchain create additional complexities when interacting with traditional banking applications.

### SUMMARY OF THE INVENTION

Distributed ledger interoperability services are disclosed. According to an embodiment, a method for transaction processing using a ledger interoperability service in a blockchain-based distributed ledger system may include: (1) receiving, at a ledger interoperability service, a pending transaction request for a transaction from a distributed banking ledger in a blockchain-based distributed ledger system, wherein a consensus algorithm operating on a plurality of distributed computer nodes in the blockchain-based distributed ledger system updates the distributed banking ledger in which multiple copies of the distributed banking ledger exist across the plurality of distributed computer nodes; (2) validating, by the ledger interoperability service, the pending transaction request; (3) enriching, by the ledger interoperability service, the validated pending transaction request with a customer account master attribute, a static account rule, and/or an account status; (4) sending, by the ledger interoperability service, a the enriched and validated pending transaction to a posting generation service, wherein the posting generation service creates a posting comprising the enriched and validated pending transaction request and a posting execution service posts a message containing the posting to the ledger interoperability service; (5) encrypting, by the ledger interoperability service, the message and providing the encrypted message to the distributed banking ledger; (6) receiving, by the ledger interoperability service, an encrypted response message from the distributed banking ledger, wherein the encrypted response indicates success or failure; (7) decrypting, by the ledger interoperability service, the encrypted response message and passing the decrypted response message to the posting execution service, wherein the posting execution service provides the posting, a transaction level status, and/or a posting level status to the posting generation service; and (8) receiving, by the ledger interoperability service, a final confirmation for the transaction.

In one embodiment, the transaction may be for a deposit transaction, a withdrawal transaction, or a transfer transaction.

In one embodiment, the pending transaction request may be encrypted.

In one embodiment, the ledger interoperability service may validate the transaction against an account existence rule, an account status rule, and/or a currency validation rule.

In one embodiment, the ledger interoperability service may validate the transaction via a real-time webservice call to a reference data services module.

In one embodiment, the ledger interoperability service may enrich the validated pending transaction request via a real-time webservice call to a structured management service module.

In one embodiment, the ledger interoperability service may format the enriched and validated pending transaction to a required communication specification for sending to the posting generation service.

In one embodiment, the ledger interoperability service may encrypt the message using a symmetric key generated with a key for the ledger interoperability service and a key for the distributed banking ledger.

In one embodiment, messages for the sending the enriched and validated pending transaction to a posting generation service, executing the postings via the posting execution service and providing the encrypted posting to the distributed banking ledger, receiving the encrypted response from the distributed banking ledger, passing the decrypted response to the posting execution service, and posting of the transaction level status and/or a posting level status to the posting generation service comprise a single message.

According to another embodiment, a ledger interoperability service in a blockchain-based distributed ledger system may include an electronic device configured to: receive a pending transaction request for a transaction from a distributed banking ledger in a blockchain-based distributed ledger system, wherein a consensus algorithm operating on a plurality of distributed computer nodes in the blockchain-based distributed ledger system updates the distributed banking ledger in which multiple copies of the distributed banking ledger exist across the plurality of distributed computer nodes; validate the pending transaction request; enrich the validated pending transaction request with a customer account master attribute, a static account rule, and/or an account status; send the enriched and validated pending transaction to a posting generation service, wherein the posting generation service creates a message comprising posting for the enriched and validated pending transaction request and a posting execution service posts a message comprising the posting to the ledger interoperability service; encrypt the message comprising the posting and providing the encrypted message to the distributed banking ledger; receive an encrypted response message from the distributed banking ledger, wherein the encrypted response indicates success or failure; decrypt the encrypted response message and passing the decrypted response to the posting execution service, wherein the posting execution service provides the posting, a transaction level status, and/or a posting level status to the posting generation service; and receive a final confirmation for the transaction.

In one embodiment, the transaction may be for a deposit transaction, a withdrawal transaction, or a transfer transaction.

In one embodiment, the pending transaction request may be encrypted.

In one embodiment, the electronic device may be configured to validate the transaction against an account existence rule, an account status rule, and/or a currency validation rule.

In one embodiment, the electronic device may be configured to validate the transaction via a real-time webservice call to a reference data services module.

In one embodiment, the electronic device may be configured to enrich the validated pending transaction request via a real-time webservice call to a structured management service module.

In one embodiment, the electronic device may be configured to format the enriched and validated pending transaction to a required communication specification for sending to the posting generation service.

In one embodiment, the electronic device may be configured to encrypt the message using a symmetric key generated with a key for the ledger interoperability service and a key for the distributed banking ledger.

In one embodiment, messages for the sending the enriched and validated pending transaction to a posting generation service, executing the postings via the posting execution service and providing the encrypted posting to the distributed banking ledger, receiving the encrypted response from the distributed banking ledger, passing the decrypted response to the posting execution service, and posting of the transaction level status and/or a posting level status to the posting generation service comprise a single message.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a depicts an architecture for a distributed ledger interoperability service according to an embodiment; and

FIG. 2 depicts a method for transaction processing using a distributed ledger interoperability service is according to an embodiment;

FIG. 3A depicts an embodiment in which a message includes one transaction containing a single posting; and

FIG. 3B depicts an embodiment in which a message includes all postings for a transaction in the message.

### DETAILED DESCRIPTION OF PREFERRED EMBODIMENTS

Embodiments are directed to distributed ledger interoperability services.

A ledger interoperability Service (LIS) may be a component that provides message transformation and orchestration from on-chain formats (e.g., blockchain formats) to off-chain formats (e.g., bank formats). A LIS may perform the deposit, transferring, and withdrawal functions by consuming reference data and structure management data from other services, and then enriching the message structure, allowing for accurate posting of balance types. A LIS may link two or more ledgers, such as off-chain ledger and on-chain ledgers, as well as associated services for one or more of the ledgers. The linkage may allow for real-time and simultaneous and atomic postings across ledgers, such as debiting a traditional off-chain DDA ledger and crediting an on-chain distributed ledger account simultaneously.

In embodiments, attributes may be written to the distributed ledger. An example of a type of attribute encompassed is if client A instructs a transfer to another client B, future dated for T+1 value. The value date attribute may be incorporated into the balance posting on to the distributed ledger.

While the process of depositing, transferring, and withdrawing may be performed by services associated with digital currencies, the LIS may be a separate service that allows for banks to properly comply with deposit record-keeping requirements.

Embodiments may include a component that provides the ability to move funds from off-chain ledgers to on-chain ledgers (e.g., a deposit process) and back (e.g., a withdrawal process).

Embodiments may include a component that provides functionality of “mass conservation” of fiat value, where the sum of the off-chain DDA balances and the sum of the on-chain balances will remain the same (i.e., a static amount) at a given point in time through the process of simultaneous postings across off-chain and on-chain ledgers. As an example, if an off-chain account has a balance of $80 U.S. dollars and the associated on-chain account has a balance of $20, the LIS can ensure the total balance across the two accounts remains at $100 so that across the processes of deposit and withdrawal, there are no net new balances created.

In embodiments, the LIS may provide some or all of the following features:

1. Real time integration with a gateway/ledger to accept deposit, transfer, and withdrawal requests;

2. Flexibility and core capability to transform any message formats to on-chain formats or to off-chain (e.g., bank system-specific) formats. The message formatter framework may be a generic component that is scalable for any message formats with minimum amount of change;

3. Integration with a posting generation service (PGS) for deposit, transfer, and withdrawal acceptance, and transaction completion. It may convert on-chain formats to bank posting formats, and vice-versa;

4. Integration with a structure management service (SMS) to enrich the on-chain message structure with customer account master attributes, static account rules, mapping, and account status as necessary and/or desired for, for example, posting formats; and

5. Integrate with a reference data service (RDS) to enrich the message structure with nostro, branch, holiday, etc., as necessary and/or desired for, for example, PGS formats.

Embodiments my enable commercial banks to issue balances on a ledger in a way that does not require uprooting their existing business processes. Embodiments facilitate posting only after required checks are done, allowing for reconciliations with existing systems, and pulling the requisite information for reporting of distributed ledger balances.

In embodiments, the ledgers may not be distributed ledgers. For example, a LIS may serve as a link between any two ledgers, such as between a hosted external ledger and a bank ledger.

In embodiment, the distributed ledger(s) may be built on distributed ledger/blockchain technology and be configured to consume and processes balance posting events. The account and balance information may be encompassed in smart contracts, and the distributed ledger may support two or more forms of transaction processing.

In embodiments, a consensus algorithm operating on a plurality of distributed computer nodes may update the distributed ledger in which multiple copies of the distributed ledger exist across the plurality of distributed computer nodes. Information may be added to a block in the blockchain-based system according to the consensus algorithm.

The first form of transaction processing involves allowing all transaction processing to happen via the distributed ledger core by using on-chain services in the form of smart contracts. Examples of such services may include screening against a permissible list of valid account addresses, checking if there are sufficient funds in the account, putting a transactional hold on funds prior to processing or a manual hold on balances to freeze funds, etc. Any suitable on-chain service may be provided as is necessary and/or desired.

The second form of transaction processing involves allowing for transaction processing to happen using off-chain services in the form of generalized micro-services. Examples of such off-chain services may include posting generation services, core banking applications, etc. Any suitable off-chain service may be provided as is necessary and/or desired.

For example, a posting generation service may perform checks and may execute one or more posting events to the distributed ledger core. The posting events may be specific to each leg of the transaction, and may include details such as: posting type (e.g., deposit or credit); account; value; booking date; value date; exposure date; and settlement date. The ledger core may process these posting events individually, and may update the respective on-chain balances on the distributed ledger.

Additionally, the distributed ledger may include functionality to account for balance types and dates. Because the distributed ledger may be available 24 hours a day, 7 days a week, and may be distributed across several time zones, it may not have a concept of system dates or business dates that are an integral part of traditional ledger systems. Thus, embodiments may provide a system business date that may maintain a view of the current/previous/next system business date that accounts for holidays and weekends. This provides compatibility with core banking applications and enables 24×7 processing of transactions by the distributed ledger core. The distributed ledger core may also include logic to manage end-of-day processing and date roll-over to update the business dates at the close of business every day.

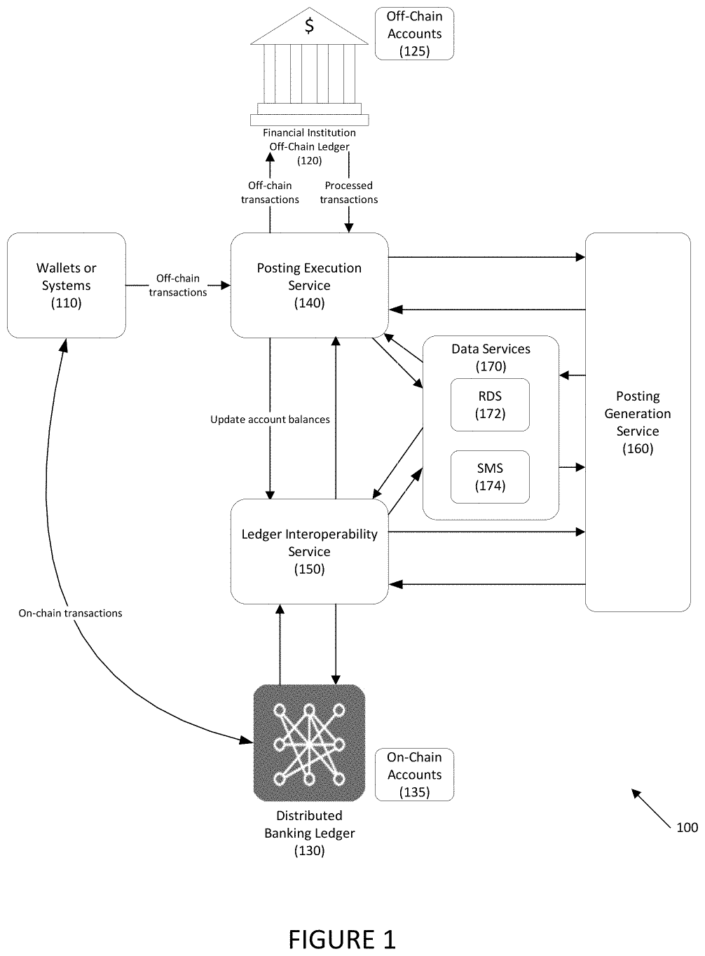

Referring to FIG. 1, a system for implementing a ledger interoperability service is provided according to one embodiment. System 100 may include wallets or systems 110, which may be executed on any suitable electronic device (not shown). Wallets or systems 110 may interact, via an application programing interface (API) with financial institution off-chain ledger 120, which may be any suitable ledger provided by a financial institution. Financial institution off-chain ledger 120 may host a plurality of off-chain accounts 125, such as demand deposit accounts.

Wallets or systems 110 may also interact, via API, with distributed banking ledger 130, which may host on-chain accounts for a plurality of financial institutions. Distributed banking ledger 130 may be a blockchain-based distributed ledger system. A consensus algorithm may operate on a plurality of distributed computer nodes, such as a node for each participating financial institution. Multiple copies of distributed banking ledger 130 may exist across the plurality of distributed computer nodes. A consensus algorithm may operate on each of the distributed computer nodes, and may update distributed banking ledger 130 by adding blocks to the blockchain-based system.

In embodiments, a plurality of financial institutions may maintain accounts on distributed banking ledger 130 and may access distributed banking ledger 130 at a distributed computer node. Each distributed computer may store a public state and a private state for each financial institution.

Examples of distributed ledgers including such states are disclosed in U.S. Patent Application Ser. No. 62/316,841 and of U.S. Pat. No. 10,749,848, the disclosures of which are hereby incorporated, by reference, in their entireties.

In one embodiment, smart contracts may be deployed to distributed banking ledger 130. The smart contracts may perform various functions, including database functions.

In one embodiment, additional distributed ledgers (not shown), such as side chains, may be provided as is necessary and/or desired. For example, the side chains may provide information about foreign exchange rate agreements, contracts, etc.

Wallets or systems 110 may interact with posting execution service 140 for off-chain transactions, such as those involving off-chain accounts 125, and may interact with distributed banking ledger 130 for on-chain transactions, such as those involving on-chain accounts 135. In one embodiment, wallets or systems 110 may interact with posting execution service 140 for balance account update interactions.

Distributed banking ledger 130 and financial institution off-chain ledger 120 may interact via ledger interoperability service 150.

Financial institution off-chain ledger 120 may communicate processed transactions to posting execution service 140, which may generate postings for distributed banking ledger 130. The postings may update the balances in on-chain accounts 135.

In embodiments, if transaction from wallet or system 110 involves off-chain processing, it may be communicated, via API, to distributed banking ledger 130, which may communicate the transaction to LIS 150. LIS 150 may provide the transaction to posting generation service 160, which may generate the postings for the transaction, and provide the postings to posting execution service 140. Posting execution service 140 may cause distributed banking ledger 130 to update account balances.

Data services 170 may interface with LIS 150 and may provide reference data service (RDS) 172 and structure management service (SMS) 172. RDS 172 may provide reference data required across micro services, such as managed rates, FX rates, calendar, currency, etc. It may further provide reference data from other source systems.

SMS 174 may enrich the on-chain message structure with customer account master attributes, static account rules, mapping, account status, and posting formats as necessary and/or desired.

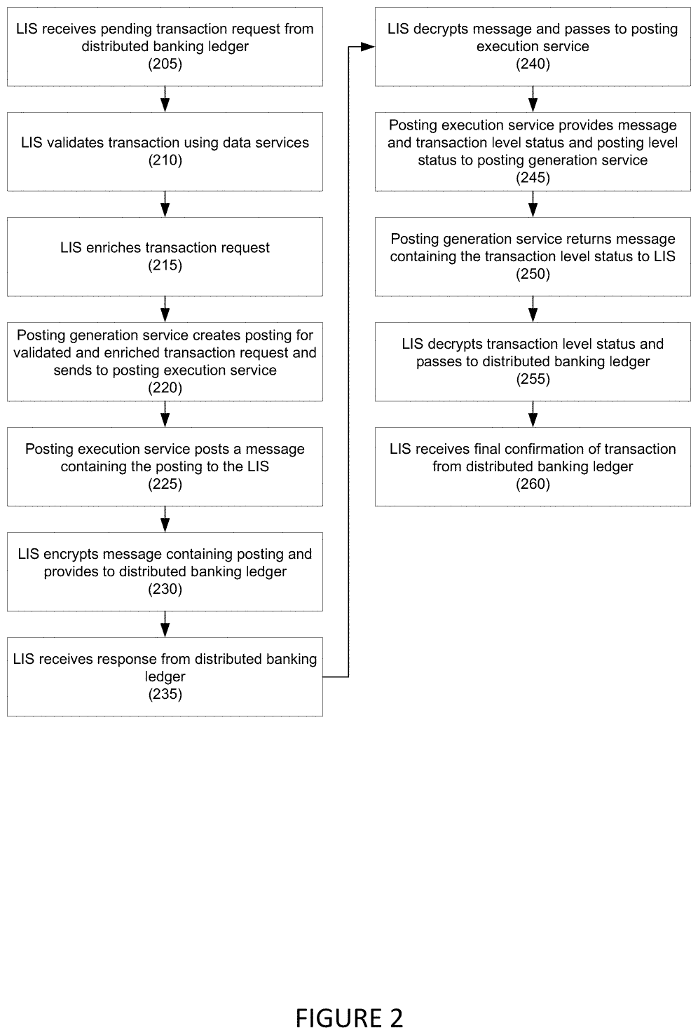

Referring to FIG. 2, a method for transaction processing using a distributed ledger interoperability service is disclosed according to an embodiment.

In step 205, a LIS may receive a pending transaction request (e.g., a deposit, withdrawal, or transfer) from a distributed banking ledger. In one embodiment, the transaction request may be received in an encrypted format. The LIS may decrypt the request and may send the request to a posting generation service.

In step 210, the LIS may validate the pending transaction request using a data services module. For example, the data services may include a reference data service (SMS) and/or a structured management service (SMS). The transaction request may be validated against attributes from the RDS and/or SMS.

In one embodiment, the LIS may validate the pending transaction request against one or more rules, such as account existence, account status, currency validation etc. This may be performed via real-time webservice calls to the RDS and/or SMS.

In step 215, the LIS may enrich the pending transaction request for posting using, for example, a structured management service (SMS). The SMS may enrich the on-chain message structure with customer account master attributes, static account rules, mapping, and account status as necessary and/or desired for, for example, posting formats.

In one embodiment, the LIS may format the enriched and validated pending transaction request to a required communication specification for sending to the posting generation service.

In step 220, the posting generation service may create a posting for the validated and enriched pending transaction request and provide the posting to a posting execution service. In one embodiment, the posting may be encrypted using, for example, symmetric key encryption. The LIS and the distributed ledger may share respective keys, such as public keys, with each other.

In step 225, the posting execution service may post a message containing the posting to LIS. The posting execution service may interface with other platforms needed for the transaction type (e.g., deposit, withdrawal, transfer). For example, for a withdrawal, the posting execution service may use the messaging capabilities of KAFKA.

In step 230, the LIS may encrypt the message containing the posting with its private key and may provide the encrypted message to the distributed banking ledger. For example, using a REST API call, the distributed banking ledger may provide its credentials, such as its public key, to the LIS to generate a token that may be used in subsequent calls.

In step 235, the LIS may receive a response message, such as a success, failure, or partial success, from a smart contract executed by the distributed banking ledger. In one embodiment, the response message may be encrypted.

In step 240, the LIS may decrypt the message from the distributed banking ledger and may pass the message to the posting execution service.

In one embodiment, the LIS may format the message to a required communication specification for sending to the posting generation service.

In step 245, the posting execution service may provide the message containing the posting, the transaction level status from the distributed banking ledger, and/or a posting level status (e.g., the status of the posting(s) the distributed banking ledger) to the posting generation service. In one embodiment, the transactions may be sent via KAFKA and, when in transit, may be encrypted by SSL. The transaction level status and/or the posting level status may be one of success, failed, or partial success.

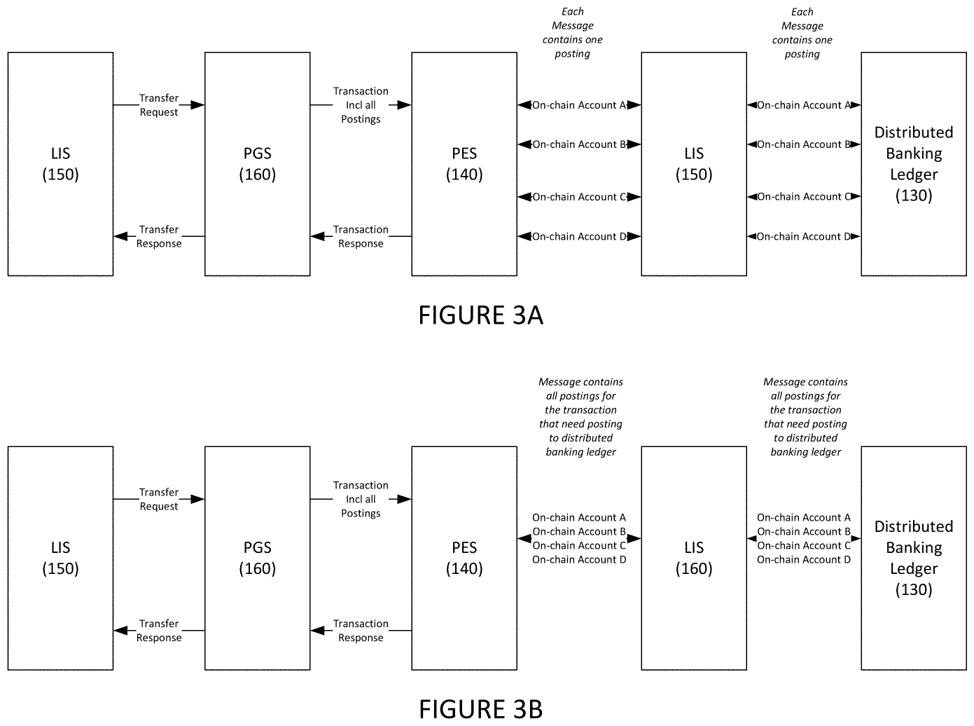

Steps 225 to 245 may be performed using multiple messages, or they may be performed using a single message. For example, FIG. 3A depicts an embodiment in which a message includes one transaction containing a single posting, and FIG. 3B depicts an embodiment in which a message includes all postings for a transaction in the message. Thus, a failure in any of the postings will cause the message to fail.

In step 250, the posting generation service provides the LIS with a message containing the transaction level status. In one embodiment, the transaction level status may be encrypted at least while in transit.

In step 255, the LIS may decrypt the transaction level status and may pass the transaction level status to the distributed banking ledger.

In step 260, a smart contract executed on the distributed banking ledger may provide final confirmation of the transaction, such as a transaction complete message. This may provide atomic commit capability.

In embodiments, messages may include manual hold processing (e.g., add/remove/inquiry), account opening while linking the on-chain account with a distributed ledger ID, which may be an identifier for the on-chain account, balance inquiry, and ingestion post end of day notification. For example, manual hold processing may place holds on accounts while processing is occurring, which, along with simultaneous posting, is part of “mass preservation.”

In one embodiment, the hold details may be sent to a number of supporting platforms processes to provide visibility of hold amounts as this impacts the availability of funds to the owners of the accounts. An example of such a platform is a regulatory system for situations in which a regulatory hold of funds is required.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for transaction processing using a ledger interoperability service in a blockchain-based distributed ledger system, comprising:
receiving, at a ledger interoperability service, a pending transaction request for a transaction from a distributed banking ledger in a blockchain-based distributed ledger system, wherein a consensus algorithm operating on a plurality of distributed computer nodes in the blockchain-based distributed ledger system updates the distributed banking ledger in which multiple copies of the distributed banking ledger exist across the plurality of distributed computer nodes;
validating, by the ledger interoperability service, the pending transaction request;
enriching, by the ledger interoperability service, the validated pending transaction request with a customer account master attribute, a static account rule, and/or an account status;
sending, by the ledger interoperability service, a the enriched and validated pending transaction to a posting generation service, wherein the posting generation service creates a posting comprising the enriched and validated pending transaction request and a posting execution service posts a message containing the posting to the ledger interoperability service;
encrypting, by the ledger interoperability service, the message and providing the encrypted message to the distributed banking ledger;
receiving, by the ledger interoperability service, an encrypted response message from the distributed banking ledger, wherein the encrypted response indicates success or failure;
decrypting, by the ledger interoperability service, the encrypted response message and passing the decrypted response message to the posting execution service, wherein the posting execution service provides the posting, a transaction level status, and/or a posting level status to the posting generation service; and
receiving, by the ledger interoperability service, a final confirmation for the transaction.

2. The method of claim 1, wherein the transaction is for a deposit transaction, a withdrawal transaction, or a transfer transaction.

3. The method of claim 1, wherein the pending transaction request is encrypted.

4. The method of claim 1, wherein the ledger interoperability service validates the transaction against an account existence rule, an account status rule, and/or a currency validation rule.

5. The method of claim 4, wherein the ledger interoperability service validates the transaction via a real-time webservice call to a reference data services module.

6. The method of claim 1, wherein the ledger interoperability service enriches the validated pending transaction request via a real-time webservice call to a structured management service module.

7. The method of claim 1, wherein the ledger interoperability service formats the enriched and validated pending transaction to a required communication specification for sending to the posting generation service.

8. The method of claim 1, wherein the ledger interoperability service encrypts the posting using a symmetric key generated with a key for the ledger interoperability service and a key for the distributed banking ledger.

9. The method of claim 1, wherein a single message comprises messages for the sending the enriched and validated pending transaction to a posting generation service, executing the postings via the posting execution service and providing the encrypted posting to the distributed banking ledger, receiving the encrypted response message from the distributed banking ledger, passing the decrypted response message to the posting execution service, and posting of the transaction level status and/or a posting level status to the posting generation service.

10. A ledger interoperability service in a blockchain-based distributed ledger system, comprising:
an electronic device configured to:
receive a pending transaction request for a transaction from a distributed banking ledger in a blockchain-based distributed ledger system, wherein a consensus algorithm operating on a plurality of distributed computer nodes in the blockchain-based distributed ledger system updates the distributed banking ledger in which multiple copies of the distributed banking ledger exist across the plurality of distributed computer nodes;
validate the pending transaction request;
enrich the validated pending transaction request with a customer account master attribute, a static account rule, and/or an account status;
send the enriched and validated pending transaction to a posting generation service, wherein the posting generation service creates a message comprising posting for the enriched and validated pending transaction request and a posting execution service posts a message comprising the posting to the ledger interoperability service;
encrypt the message comprising the posting and providing the encrypted message to the distributed banking ledger;
receive an encrypted response message from the distributed banking ledger, wherein the encrypted response indicates success or failure;
decrypt the encrypted response message and passing the decrypted response to the posting execution service, wherein the posting execution service provides the posting, a transaction level status, and/or a posting level status to the posting generation service; and
receive a final confirmation for the transaction.

11. The ledger interoperability service of claim 10, wherein the transaction is for a deposit transaction, a withdrawal transaction, or a transfer transaction.

12. The ledger interoperability service of claim 10, wherein the pending transaction request is encrypted.

13. The ledger interoperability service of claim 10, wherein the ledger interoperability service validates the transaction against an account existence rule, an account status rule, and/or a currency validation rule.

14. The ledger interoperability service of claim 13, wherein the ledger interoperability service validates the transaction via a real-time webservice call to a reference data services module.

15. The ledger interoperability service of claim 10, wherein the ledger interoperability service enriches the validated pending transaction request via a real-time webservice call to a structured management service module.

16. The ledger interoperability service of claim 10, wherein the ledger interoperability service formats the enriched and validated pending transaction to a required communication specification for sending to the posting generation service.

17. The ledger interoperability service of claim 10, wherein the ledger interoperability service encrypts the posting using a symmetric key generated with a key for the ledger interoperability service and a key for the distributed banking ledger.

18. The ledger interoperability service of claim 10, wherein messages for the sending the enriched and validated pending transaction to a posting generation service, executing the postings via the posting execution service and providing the encrypted posting to the distributed banking ledger, receiving the encrypted response message from the distributed banking ledger, passing the decrypted response message to the posting execution service, and posting of the transaction level status and/or a posting level status to the posting generation service comprise a single message.
